(19) United States
(12) Patent Application Publication
(10) Pub. No.: US 2002/0112614 A1
(43) Pub. Date: Aug. 22, 2002

(54) Free-standing bakable food product receptacle for bakery items and method of use

(76) Inventor: Robert A. Zoss, Plymouth, MN (US)

Correspondence Address: John A. O'Toole, Esq., P.O. Box 1113, Minneapolis, MN, 55440, US

(21) Appl. No.: 09/789,208

(22) Filed: Feb. 20, 2001

(51) Int. Cl. A23L 1/00; A47J 43/18

(52) U.S. Cl. 99/426; 99/353

(57) ABSTRACT

A baking receptacle for baking a food product in an oven, including baking items such as muffins, cakes, rolls, etc. The receptacle is comprised of a sheet of thin ovenable material formed to define a bottom, a side wall, and a folded top portion. The side wall extends from the bottom and forms readily expandable, longitudinal pleats. The folded top portion extends from the sidewall opposite the bottom and includes, in one preferred embodiment, a first section, a second section, and a third section. The first section is folded relative to the side wall such that a first fold angle is defined by the side wall and the first section. Similarly, the second section is folded relative to the first section such that a second fold angle is defined by the first section and the second section. Finally, the third section is folded relative to the second section such that a third fold angle is defined by the second section and the third section. With these definitions in mind, the second and third fold angles are each less than 90°. With this configuration, the folded top portion will substantially prevent expansion of the longitudinal pleats opposite the bottom. Thus, during a baking operation, the receptacle will maintain its integrity in response to an internal expansion force generated by a contained bakable food product, independent of any other support structures. In one preferred embodiment, the first section of the folded top portion forms a ledge for supporting a bakable food product otherwise expanding or rising outwardly from the side wall during baking, such as a muffin crown. In another preferred embodiment, the receptacle is formed to define an irregular peripheral shape, such as a heart.

### BACKGROUND OF THE INVENTION

The present invention relates to a thin, ovenable material receptacle for baking a food product. More particularly, it relates to a free-standing, ovenable material receptacle able to independently maintain its structural integrity with expansion of a contained baked good product during a baking operation.

The preparation of a wide variety of food products requires baking. For example, bakery items, such as breads, rolls, pastries, cakes, etc., are initially mixed and, depending upon the particular ingredients, formed as either a dough or batter. The resulting dough or batter (or “bakable food product”) is subsequently baked in an oven, culminating in the final, baked good product.

Most batters are highly viscous and cannot be properly baked unless placed within a container. Further, it is often times desirable for a dough or batter to be formed to a certain shape during baking. For many baking applications, then, the batter or dough is maintained within a formed pan during baking. For example, cake pans and muffin pans are commonly used to bake cakes and muffins, respectively. The pan serves to not only contain a viscous batter, but also to “force” a batter or dough to assume a desired shape as it expands or rises. For example, a circular-shaped cake pan produces a round cake, whereas a square-shaped cake pan dictates a square cake. The pan itself is highly rigid and will not deform in response to the forces generated by the contained dough or batter as it expands. Additionally, it is common for the particular dough or batter to desirably expand to a volume exceeding that of the pan, such that the baked good “rises” above a top of the pan. For example, a baked muffin typically forms a “crown” that extends not only above the pan, but also outwardly beyond the original muffin baking space. In this regard, the muffin pan forms a top flange that supports the crown during baking.

Virtually all available baking pans are metal-based, such as aluminum. While highly viable, metal baking pans are relatively expensive, and though reusable, must be washed between uses. Unavoidable burning of the batter or dough renders this task quite difficult. In addition, the metal baking pan may include a number of connected cups or receptacles. For example, a muffin-baking pan is relatively large, and forms six, twelve, or twenty-four cups. Where the quantity of baked good items desired by the consumer is less than the number of cups formed by the baking pan, the entire pan must still be placed within the oven, thereby minimizing available oven space for other products. Also, although metal baking pans are thermally conductive, non-uniform baking typically occurs due to the inability of moisture to escape through the baking pan's walls. Finally, metal baking pans cannot be used within a microwave.

Efforts have been made to overcome several of the above-identified deficiencies associated with metal baking pans. In particular, a paper-based muffin pan has been envisioned. The impetus for a paper-based muffin pan likely arose from the decorative paper liners normally associated with muffins. In general terms, these decorative liners are formed to include a longitudinally pleated side wall within which the muffin batter is disposed. The pleated configuration is implemented so that the liner, and thus the resulting muffin, can expand in diameter during baking. In fact, consumers have come to expect that muffins will be baked within a decorative, pleated liner, and will have a contour conforming with the pleats upon removal of the liner.

With the above background in mind, U.S. Pat. Nos. 4,986,532 and 5,217,631, both assigned to Novacart S.P.A., describe a baking pan including a plurality of paper-based cups. Each of the paper cups forms longitudinal pleats as well as an outer, circumferential engagement groove at an upper end thereof. The engagement groove is configured for positioning the cup within an opening formed by a rigid, lateral support structure. A number of similarly formed lateral support structures can be connected to one another to define a relatively large tray for simultaneously baking a desired number of products. Conversely, a single tray having a series of cup-receiving holes can be provided. Regardless, the lateral support structure is necessary to support the paper cup during baking. In particular, as previously described, the muffin batter contained within the cup will greatly expand during baking. This expansion imparts an internal force onto the pleated, paper cup. Without the lateral support structure, the pleats would simply unfold in response to this expansion force, thereby destroying the cup's integrity. Further, it is preferred that the muffin batter rise above a top of the cup and expand outwardly to form a crown. Under these circumstances, the paper cup is in and of itself unable to “support” the crown, and the lateral support structure is again required. While viable, the Novacart technique entails the additional expense of the lateral support structure. In addition, it is limited to circular-type baked good items.

An alternative paper-based muffin baking pan as been suggested whereby the “standard” decorative liner is formed with a greatly thickened (or weighted) paper. For example, it has been proposed to utilize a paper product having a weight of approximately 50 pounds per ream and forming a “standard” muffin liner. As a point of reference, most decorative muffin liners are made from a paper having a weight of less than approximately 25 pounds per ream. In theory, by forming the liner with a heavier material, the liner itself should be more rigid. Unfortunately, however, the heavy muffin liners have not been found to provide uniformly acceptable results. Instead, the thickened muffin liner undesirably unfolds and deforms in response to expansion of the contained baked good items during baking. Further, the heavy paper liner is unable to support a top portion of the baked good item, such as a muffin crown. Finally, the heavier paper material acts as an insulator, negatively impacting heat transfer to the contained product, thereby increasing requisite baking time.

Baking pans have essentially remained unchanged for decades. Unfortunately, the expense and inconvenience associated with these pans remain. Therefore, a need exists for a thin walled, free-standing baking receptacle configured to independently maintain its integrity during a baking operation.

### SUMMARY OF THE INVENTION

One aspect of the present invention provides a baking receptacle for baking a food product in an oven. The receptacle is comprised of a sheet of thin, ovenable material formed to define a bottom, a side wall, and a folded top portion. The side wall extends from the bottom and forms readily expandable, longitudinal pleats. The folded top portion extends from the side wall opposite the bottom and includes, in one preferred embodiment, a first section, a second section, and a third section. The first section is folded relative to the side wall such that a first fold angle is defined by the side wall and the first section. Similarly, the second section is folded relative to the first section such that a second fold angle is defined by the first section and the second section. Finally, the third section is folded relative to the second section such that a third fold angle is defined by the second section and the third section. With these definitions in mind, the second and third fold angles are each less than 90°. With this configuration, the folded top portion will substantially prevent expansion of the longitudinal pleats opposite the bottom. Thus, during a baking operation, the receptacle will maintain its integrity in response to an internal expansion force generated by a contained bakable food product, independent of any other support structures. In one preferred embodiment, the first section of the folded top portion forms a ledge for supporting a bakable food product otherwise expanding or rising outwardly from the side wall during baking, such as a muffin crown. In another preferred embodiment, the receptacle is formed to define an irregular peripheral shape, such as a heart.

Another aspect of the present invention relates to a packaged good item including a bakable food product contained by an ovenable paper baking receptacle. The receptacle is comprised of a sheet of thin, ovenable material formed to define a bottom, a sidewall, and a folded top portion. The side wall extends from the bottom and forms readily expandable, longitudinal pleats. The folded top portion extends from the sidewall opposite the bottom and includes, in one preferred embodiment, a first section, a second section, and a third section. As described above, the folded top portion will is configured to substantially prevent expansion of the longitudinal pleats opposite the bottom independent of any auxiliary support structures. The bakable food product is contained with a storage region defined by the sidewall and the bottom, and can assume a wide variety of forms. For example, the bakable food product can be a batter or a dough, and can be frozen or unfrozen. During a baking operation, the receptacle will maintain its integrity and not unfold in response to a force generated by expansion of the bakable food product.

Yet another aspect of the present invention relates a method of baking a food product. The method includes providing a thin, ovenable material baking receptacle forming a bottom, a side wall, and a folded top portion. The side wall extends from the bottom and forms longitudinal, readily expandable pleats. Further, the folded top portion extends from the side wall opposite the bottom and forms a plurality of folds. With this configuration, the folded top portion substantially prevents expansion of the longitudinal pleats opposite the bottom. A bakable food product is provided in an unbaked state. The bakable food product is disposed within the receptacle. The receptacle is then placed into an oven, whereby the side wall and the folded top portion are otherwise unsupported. Finally, the bakable food product is baked within the oven. Thus, unlike existing methodologies, the method of the present invention eliminates the steps of using a metal baking pan or an auxiliary support structure.

### BRIEF DESCRIPTION OF THE DRAWINGS

FIG. 1 is a perspective view of a baking receptacle in accordance with the present invention;

FIG. 2A is an enlarged, cross-sectional view of a portion of the baking receptacle of FIG. 1;

FIG. 2B is an enlarged, cross-sectional view of a portion of an alternative baking receptacle in accordance with the present invention;

FIG. 2C is an enlarged, cross-sectional view of a portion of another alternative baking receptacle in accordance with the present invention;

FIG. 3A-3B are cross-sectional view of the baking receptacle of FIG. 1 including a baked food product; and

FIG. 4A-4D are top views illustrating alternative baking receptacles in accordance with the present invention.

### DESCRIPTION OF THE PREFERRED EMBODIMENTS

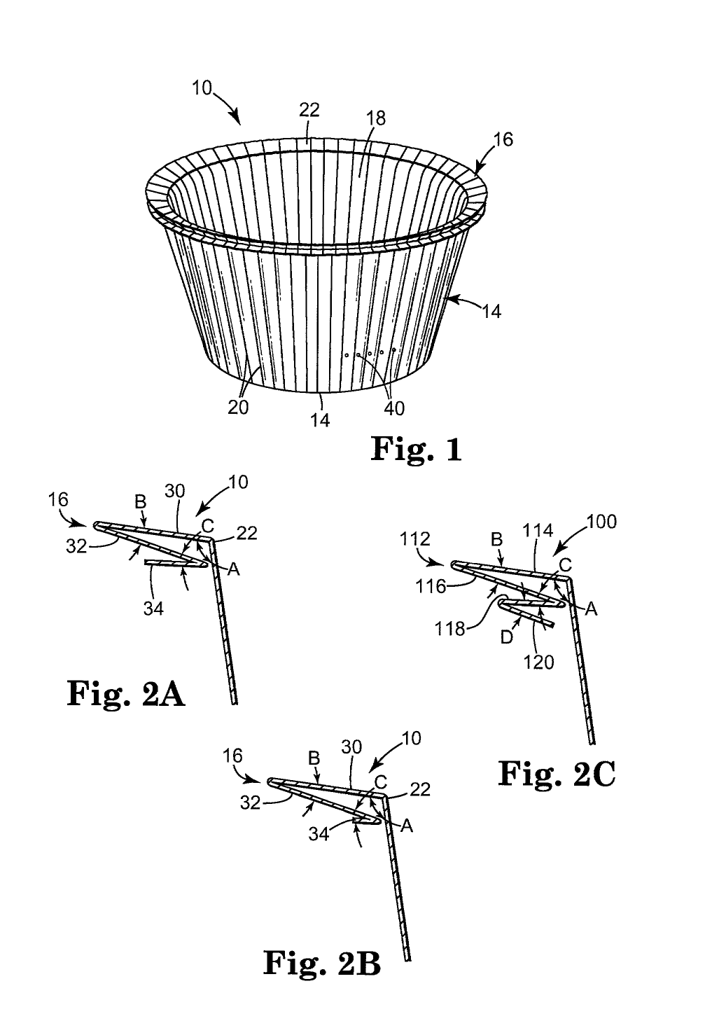

One preferred embodiment of a baking receptacle 10 is illustrated in FIG. 1. The baking receptacle 10 defines a bottom 14 (shown partially in FIG. 1), a sidewall 14, and a folded top portion 16. Details on the various components are provided below. In general terms, however, the baking receptacle 10 is sized to contain a bakable food product (not shown). During a baking operation in which the bakable food product expands, the folded top portion 16 prevents the sidewall 14 from deforming opposite the bottom 14 independent of any auxiliary support structures.

The baking receptacle 10 is formed from a sheet of ovenable paper stock. As is known in the art, “ovenable paper” is in reference to paper stock that will not burn or scorch at temperatures in upwards of 500° F., and are approved for direct contact with food. In addition, the selected ovenable material is relatively thin or low weight. For example, in one preferred embodiment, the material has a weight of not more than 30 pounds per ream, more preferably approximately 25 pounds per ream (where a ream is defined as 3,000 square feet). Other weights are equally acceptable, it being understood, however, that a lighter weight material is preferred for optimizing heat transfer through the baking receptacle 10 during a baking operation. In one preferred embodiment, the ovenable material is ovenable paper stock. Examples of acceptable ovenable paper stock material include natural Kraft paper or wax coated Kraft paper. Alternatively, the ovenable material can be a metallized paper (e.g., combination of paper and foil, such as aluminum foil, layers), or a foil alone (e.g., aluminum foil). In another preferred embodiment, an inner surface 18 of the baking receptacle 10 is coated with a non-stick or similar release material that facilitates removal of a baked food product (not shown) from the baking receptacle 10 following baking.

In the one preferred embodiment of FIG. 1, the baking receptacle 10 is configured for baking a muffin. Thus, in accordance with a standard muffin shape, the bottom 14 is preferably circular, forming a bottom of the receptacle 10. Alternatively, and as described in greater detail below, the baking receptacle 10 can assume a wide variety of other shapes, such that the bottom 14 is something other than circular.

The sidewall 14 extends upwardly from the bottom 14 and forms a plurality of longitudinal pleats 20. As is commonly found with decorative muffin liners, the pleats 20 are readily expandable, and facilitate the baking receptacle 10 having an increased outer dimension at a top 22 relative to the bottom 14.

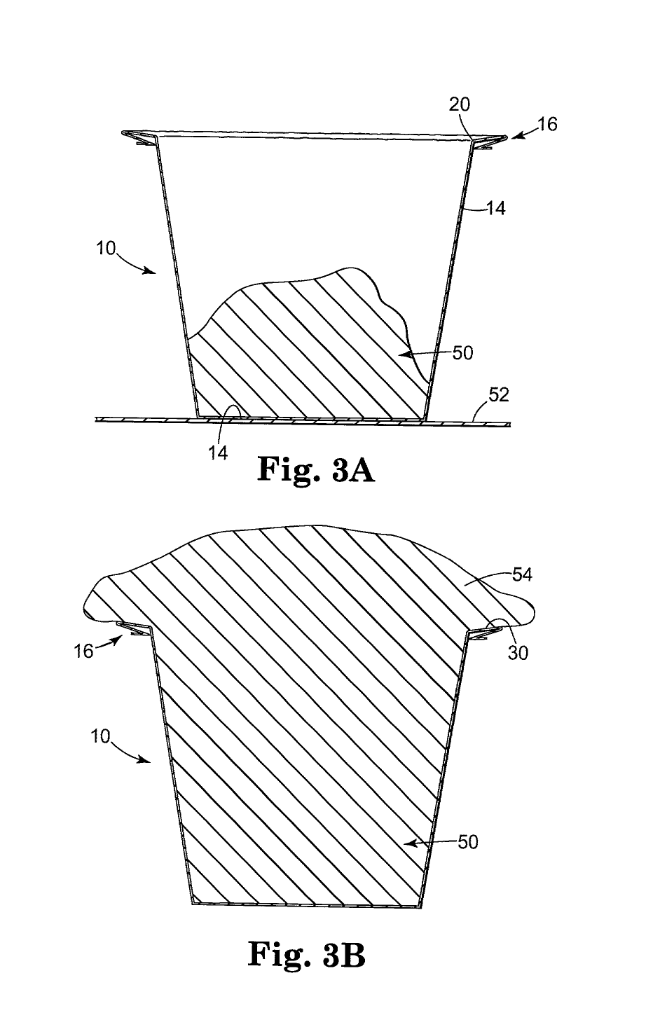

The folded top portion 16 extends from the top 22 of the sidewall 14, opposite the bottom 14. As shown in FIG. 1, the pleats 20 continue through the folded top portion 16. As shown in FIG. 2A, in one preferred embodiment, the folded top portion 16 includes a first section 30, a second section 32, and a third section 34. The first section 30 extends from, and is folded relative to, the side wall 14. Thus, a first fold angle A is defined by the side wall 14 and the first section 30. Similarly, the second section 32 extends from, and is folded relative to, the first section 30. Thus, a second fold angle B is defined by the first section 30 and the second section 32. Finally, the third section 34 extends from, and is folded relative to, the second section 32. Thus, a third fold angle C is defined by the second section 32 and the third section 34.

With additional reference to FIG. 1, the folded top portion 16 provides circumferential support to the baking receptacle 10 at the top 22. In particular, the folded top portion 16 substantially prevents the pleats 20 and the sidewall 14 from expanding at the top 22 when the baking receptacle 10 is subjected to internal expansion forces typically generated by batter or dough during a baking operation. In this regard, the first fold angle A is preferably approximately 90° such that the first section 30 forms a ledge or rim for supporting food product expanding outwardly from or above the top 22 as described in greater detail below. In addition, to maximize the circumferential support provided by the folded top portion 16, the second and third fold angles B, C are less than 90°, preferably less than 60°, more preferably less than 30°. By thus forming the second and third fold angles B, C as “tight” creases, the folded top portion 16 stabilizes the side wall 14, again preventing undesired, overt expansion of the pleats 20. Notably, this desired stability would be lessened with fold angles greater than 90°. Further, because the folded top portion 16 is able to independently maintain the overall circumferential integrity of the baking receptacle 10 without an auxiliary support structure or tray, the folded top portion 16 need not form a circumferential engagement groove. In other words, formation of a circumferential engagement groove would require that at least the third fold angle C exceed 90°, detracting from an overall strength of the folded top portion 16.

An additional preferred characteristic of the folded top portion 16 is that the first and second sections 30, 32 define an outer perimeter of the baking receptacle 10. That is to say, each of the second and third sections 32, 34 preferably have a radial width or outer dimension less than that of the first section 30. With this preferred configuration, the baking receptacle 10 has a uniform, aesthetically pleasing appearance, is more readily manufactured, and does not “waste” any of the paperboard material. In particular, the folded top portion 16 is preferably formed by folding the paperboard material otherwise defining the baking receptacle 10. This folding operation is most conveniently performed by defining the third section 34 to have a radial width or outer dimension less than that of the second section 32, and forming the second section 32 to have a radial width or outer dimension less than that of the first section 30. Further, because the folded top portion 16 derives its circumferential strength from the various folds and the first section 30 provides a ledge for a food product “crown”, the second and third sections 32, 34 are preferably as small as possible (in terms of outer dimension and radial width) to minimize the required amount of material and therefore cost. For example, FIG. 2B depicts an alternative embodiment in which the third section 34 has a greatly reduced radial width.

The configuration of the folded top portion 16 illustrated in FIG. 2A is but one acceptable design. Alternatively, the third section 34 can be eliminated from the folded top portion 16, or the folded top portion 16 can include additional sections, and thus additional fold angles, extending from the third section 34. Additionally, the second and third fold angles B, C need not be substantially identical as otherwise illustrated in FIG. 2A. Essentially, the circumferential stability or support provided by the folded top portion 16 is enhanced with each additional section and related fold. However, providing additional sections (and thus additional folds) beyond the three sections 30-34 illustrated in FIG. 2A entails additional manufacturing steps and material. Surprisingly, it has been found that for most applications, providing the folded top portion 16 with the first and second sections 30, 32, more preferably all three sections 30-34, provides sufficient circumferential support to the baking receptacle 10 for many single serving-sized bakable food products, with minimal manufacturing implications. Alternatively, where the folded top portion 16 is formed to include additional sections (and fold angles), the additional sections preferably conform with the parameters set forth above. For example, FIG. 2C illustrates an alternative baking receptacle 100 including a folded top portion 112 with four sections 114-120 and four fold angles A-D. The fold angles B-D are each preferably less than 90°, more preferably less than 60°, and most preferably less than 30°. Further, the outer dimension of the first and second sections 114, 116 (defined at the fold angle B) is preferably greater than that of the third and fourth sections 118, 120. Finally, although exaggerated in FIG. 2C for purposes of illustration, the second, third and fourth sections 116-120 are preferably of minimal radial width. It will be understood that, depending upon the size of the receptacle 100 and a weight of the contained bakable food product (not shown), additional sections/folds may further be provided.

Returning to FIG. 1, in one preferred embodiment, the sidewall 14 is further formed to include a plurality of holes 40. As a point of reference, a size of each of the holes 40 has been greatly exaggerated in FIG. 1 for purposes of illustration. The holes 40 can be formed by known perforation manufacturing techniques, such as laser scoring, and facilitate release of moisture from an interior of the baking receptacle 10. Thus, unlike existing thick, metal-based baking pans, the baking receptacle 10 of the present invention promotes reduced baking time by allowing release of moisture from the contained bakable food product (not shown) through the holes 40. In one preferred embodiment, the holes 40 each have a diameter of approximately 30-80 microns, and are uniformly disposed along a circumference of the side wall 14. Alternatively, other dimensions and locations are equally acceptable. In addition, or alternatively, the holes 40 can be formed through the bottom 14.

During use, and as shown in FIG. 3A, a bakable food product 50 is disposed within the baking receptacle 10 in an unbaked state. In the unbaked state, the bakable food product 50 preferably has a volume (e.g., 4 ounces of muffin batter) less than an available volume of the baking receptacle 10. The baking receptacle 10 is then placed within an oven (not shown), such as a conventional oven. Where the receptacle 10 is formed from an ovenable paper, a microwave oven may alternatively be used. Regardless, the baking receptacle 10 can be placed on top of a baking sheet, such as cookie sheet 52. Beyond this, however, the baking receptacle 10 is unsupported. That is to say, the baking receptacle 10 is not placed within a separate metal pan, or within a rigid, lateral support structure or tray.

As the baking receptacle 10 and the bakable food product 50 are baked within the oven, the bakable food product 50 will expand. This expansion places an internal force on the side wall 14. Without the folded top portion 16, the pleats 20 otherwise formed by the side wall 14 would greatly expand or unfold, especially at the top 22, likely resulting in failure of the baking receptacle 10. The folded top portion 16 prevents this from occurring. More particularly, the folded top portion 16 substantially prevents the pleats 20 from expanding or unfolding at the top 22. It is understood that the relatively low weight characteristic of the paperboard material selected for the baking receptacle 10 may allow the pleats 20 to slightly expand below the top 22. However, by substantially preventing, preferably entirely preventing, the pleats 20 from expanding or unfolding at the top 22, the baking receptacle 10 will not fail in response to expansion of the contained bakable food product 50.

With certain applications, it is desired that the bakable food product 50 expand above and outwardly relative to the top 22. For example, where the bakable food product 50 is a muffin batter, it is desired that the resulting baked food product (or muffin) 50 form a crown 52 as shown in FIG. 3B. In this regard, the first section 30 of the folded top portion 16 provides a ledge or rim that independently supports the crown 52.

The above-described configuration renders the baking receptacle 10 highly applicable for use with a wide variety of different bakable food products. For example, the bakable food product 50 (and resulting baked good item) can include muffins, cakes, rolls, breads, pastries, etc. The bakable food product 50 can be contained within the baking receptacle 10 in either a frozen or unfrozen state. Further, the baking receptacle 10 can be provided to a consumer (not shown) with the bakable food product 50 already disposed therein as a packaged good article. Alternatively, the baking receptacle 10 can be sold separately, with the consumer generating their own bakable food product 50 and placing the same within the receptacle 10 for subsequent baking.

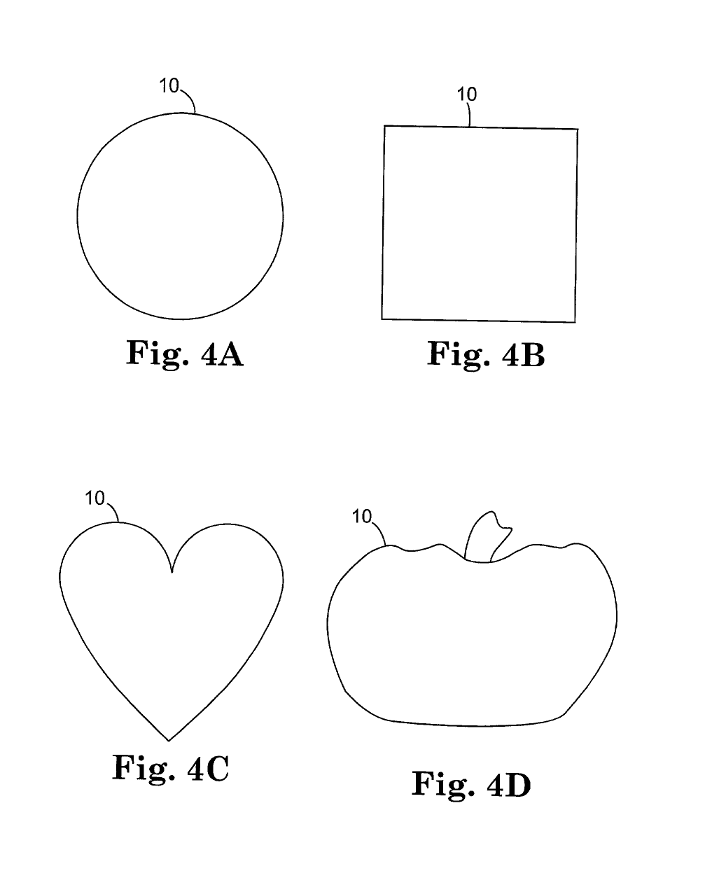

In addition to being useful with a wide variety of different bakable food products, the baking receptacle 10 can form the resulting food product to a wide variety of different shapes. For example, as shown in FIG. 4A, the baking receptacle 10 can be formed to define a circular perimeter. Alternatively, FIG. 4B illustrates a square perimeter. Even further, the baking receptacle 10 can form a wide variety of irregular shapes. For example, FIGS. 4C and 4D illustrate a heart and a pumpkin, respectively. Essentially, the perimeter shapes formable by the baking receptacle 10 of the present invention is limitless, and can include letters, numbers, symbols, animals, cartoon characters, fanciful shapes, holiday-related icons, etc.

The baking receptacle 10 can be formed to assume a number of different sizes. In one preferred embodiment, the baking receptacle 10 is sized to contain a single serving bakable food product, for example, a single muffin. As a result, a consumer desiring to bake only a single one of the bakable food product (e.g., a single muffin) need only place a single baking receptacle 10 in the oven, thereby occupying only a small portion of the available oven space. This is in direct contrast to conventional baking pans (e.g., muffin pans). Further, the reduced size of the baking receptacle 10 allows the consumer to simultaneously bake different bakable food products within the same oven. For example, a circular baking receptacle 10 containing a muffin batter and a square baking receptacle (not shown) containing a Danish pastry dough can be baked at the same time, as the respective baking receptacles occupy only a limited amount of available oven space.

The baking receptacle of the present invention provides a marked improvement over previous designs. By employing a lightweight, material, the baking receptacle is highly inexpensive and, where an ovenable paper stock material is used, is microwaveable. Further, the baking receptacle maintains its structural integrity independent of any auxiliary components.

Although the present invention has been described with reference to preferred embodiments. Workers skilled in the art will recognize that changes can be made in form and detail without departing from the spirit and scope of the present invention.

What is claimed is:

1. A baking receptacle for baking food in an oven, the receptacle comprising a sheet of thin, ovenable material formed to define:
a bottom;
a side wall extending from the bottom end forming longitudinal, readily expandable pleats; and
a folded top portion extending from the side wall opposite the base, the top portion including:
a first section folded relative to the side wall such that a first fold angle is defined by the side wall and the first section,
a second section folded relative to the first section such that a second fold angle is defined by the first section and the second section,
a third section folded relative to second section such that a third fold angle is defined by the section and the third section,
wherein the second and third fold angles are each less than 90°; wherein the folded top portion is configured to substantially prevent
expansion of the longitudinal pleats opposite the bottom.

2. The baking receptacle of claim 1, wherein the folded top portion is configured to prevent expansion of the longitudinal pleats opposite the bottom in response to a force generated by an expanding baked good item contained within an interior of the side wall.

3. The baking receptacle of claim 1, wherein each of the second and third fold angles is less than 60°.

4. The baking receptacle of claim 3, wherein each of the second and third fold angles is less than 30°.

5. The baking receptacle of claim 1, wherein the first fold angle is approximately 90°.

6. The baking receptacle of claim 5, wherein the first section forms a ledge for supporting a baked good food product otherwise expanding outwardly above the side wall.

7. The baking receptacle of claim 1, wherein the folded top portion further includes a fourth section folded relative to the third section such that a fourth fold angle is defined by the third and fourth sections, and further wherein the fourth fold angle is less than 90°.

8. The baking receptacle of claim 7, wherein each of the third and fourth sections extend to an outer dimension less than an outer dimension of the first section.

9. The baking receptacle of claim 1, wherein the top portion is characterized by an absence of a circumferential, tray-receiving groove.

10. The baking receptacle of claim 1, wherein the ovenable material is ovenable paper stock.

11. The baking receptacle of claim 1, wherein the sheet of ovenable paper has a weight of not more than 30 pounds per ream.

12. The baking receptacle of claim 1, wherein the sheet of ovenable paper forms a plurality of holes in at least one of the bottom and the side wall for allowing passage of moisture from an interior of the baking receptacle.

13. The baking receptacle of claim 1, wherein the side wall defines a peripheral shape, and further wherein the top portion is configured to maintain the peripheral shape when the side wall is subjected to an interior, expansive force.

14. The baking receptacle of claim 13, wherein the peripheral shape is a regular shape.

15. The baking receptacle of claim 15, wherein the regular shape is square.

16. The baking receptacle of claim 14, wherein the peripheral shape is irregular.

17. The baking receptacle of claim 16, wherein the irregular shape is a heart.

18. A packaged good item for forming a baked good product in an oven, the packaged good article comprising:
a thin ovenable material baking receptacle forming:
a bottom;
a sidewall extending from the bottom end forming longitudinal, readily expandable pleats;
a folded top portion extending from the side wall opposite the base, the top portion including:
a first section folded relative to the sidewall such that a first fold angle is defined by the sidewall and the first section,
a second section folded relative to the first section such that a second fold angle is defined by the first section and the second section,
a third section folded relative to second section such that a third fold angle is defined by the section and the third section,
wherein the second and third fold angles are each less than 90°;
wherein the folded top portion is configured to substantially prevent expansion of the longitudinal pleats opposite the bottom; and
a bakable food product contained within the baking receptacle.

19. The packaged good item of claim 18, wherein the folded top portion is configured to prevent expansion of the longitudinal pleats opposite the bottom in response to a force generated by expansion of the bakable food product.

20. The packaged good item of claim 18, wherein each of the second and third fold angles is less than 60°.

21. The packaged good item of claim 20, wherein each of the second and third fold angles is less than 30°.

22. The packaged good item of claim 18, wherein the first section forms a ledge for supporting the bakable food product otherwise expanding outwardly above the side wall.

23. The packaged good item of claim 18, wherein the top portion is characterized by an absence of a peripheral, tray-receiving groove.

24. The packaged good item of claim 18, wherein the baking receptacle is formed from a sheet of ovenable paper having a weight of not more than 30 pounds per ream.

25. The packaged good item of claim 18, wherein the baking receptacle forms a plurality of holes in at least one of the bottom and the side wall for allowing passage of moisture from an interior of the baking receptacle.

26. The packaged good article of claim 18, wherein the bakable food product is a dough.

27. The packaged good article of claim 18, wherein the bakable food product is a batter.

28. The packaged good article of claim 18, wherein the bakable food product is frozen.

29. The packaged good article of claim 18, wherein the bakable food product is unfrozen.

30. A method of baking a food product, the method comprising:
providing a thin ovenable material baking receptacle forming a bottom, a side wall, and a folded top portion, wherein the side wall extends from the bottom and forms longitudinal, readily expandable pleats, and further wherein the folded top portion extends from the side wall opposite the bottom and forms a plurality of folds such that the folded top portion is configured to substantially prevent expansion of the longitudinal pleats opposite the bottom;
providing a bakable food product in an unbaked state;
disposing the bakable food product within the baking receptacle;
placing the baking receptacle into an oven, whereby the side wall and the folded top portion are otherwise unsupported; and
baking the bakable food product.

31. The method of claim 30, wherein the bakable food product expands upon baking, the method further comprising:
preventing the pleats from expanding opposite the bottom when baking the bakable food product.

32. The method of claim 31, wherein the folded top portion is configured to prevent the pleats from expanding.

33. The method of claim 32, wherein the folded top portion prevents the pleats from expanding without an auxiliary support device.

34. The method of claim 30, wherein the bakable food product is configured to expand to a volume greater than a volume of the receptacle such that the bakable food product expands over the folded top portion to form a crown upon baking, the method further comprising:
supporting the crown with the folded top portion.

35. The method of claim 30, wherein providing a baking receptacle includes providng a baking receptacle comprised of an ovenable paper having a weight of not more than 30 pounds per ream.

36. The method of claim 30, wherein providing a baking vessel includes providing the folded top portion with at least two folds.

37. The method of claim 36, wherein the folded top portion is provided with at least three folds.

38. The method of claim 30, wherein the baking occurs within a microwave oven.
